(19) United States
(12) Patent Application Publication
(10) Pub. No.: US 2026/0350474 A1
(43) Pub. Date: Nov. 5, 2026

(54) SYSTEM AND METHOD FOR CLASSIFICATION TRAINING USING CLASS-CONDITIONAL DIVERGENCE-BASED OPTIMIZATION

(71) Applicant: FAIR ISAAC CORPORATION, Minneapolis, MN (US)

(72) Inventor: Gerald Fahner, Austin, TX (US)

(21) Appl. No.: 19/668,733

(22) Filed: May 5, 2026

Related U.S. Application Data
(60) Provisional application No. 63/800,030, filed on May 5, 2025.

(51) Int. Cl. G06N 20/00

(52) U.S. Cl. CPC G06N 20/00

(57) ABSTRACT

The current subject matter relates to methods, systems, and computer-readable media that are operative to result in tuning performance of a model architecture. Consistent with this approach, a training dataset is processed using a model architecture configured to generate, for each data instance of the training dataset, an output score indicative of a predicted class probability. The training dataset includes a plurality of labeled data instances, where each data instance associated with a binary label. A class-conditional divergence metric maximized for a fixed value of a weighting factor is computed. The weighting factor is configured to adjust a relative penalization applied to a variance of each class. Parameters of the model architecture are optimized by maximizing the class-conditional divergence metric for a fixed value of the weighting factor (e.g., omega).

### CROSS REFERENCE

This application claims priority under 35 U.S.C. § 119 to U.S. Provisional Patent Application No. 63/800,030 filed on May 5, 2025, the entire contents of which is hereby expressly incorporated by reference herein.

### TECHNICAL FIELD

The subject matter described herein relates to model construction, specifically to systems and methods for training binary classification models using class-conditional divergence-based analysis to improve class separation and output score distribution control.

### BACKGROUND

In the context of binary classification systems, especially those deployed in high-stakes environments such as medical diagnostics, spam filtering, biometric access control, and quality assurance in manufacturing, predictive models are often expected not only to be accurate but also to exhibit stable and interpretable output score distributions. Often times, model outputs are required to conform to specific score ranges, transformation profiles, or distributional expectations to support business processes, reporting, or downstream calibration. However, when a updates to a predictive model are developed and implemented, the raw output distribution of the predictive model may no longer align with these operational constraints. For example, when mapping log (odds) outputs to score ranges, the resulting values may exceed required bounds, exhibit nonlinear transformations that distort interpretability, or violate assumptions about score monotonicity. Common mitigation strategies, such as clamping scores or applying compound non-linear scaling layers, may negatively impact rank-ordering performance or introduce unnecessary complexity and opacity to the model pipeline. Accordingly, there remains a need for techniques that enable configurable control over the score transformation and distribution characteristics during model training or calibration, while preserving performance and maintaining compatibility with established scoring systems and operational workflows. In many operational scoring environments, a near-linear transformation between model scores and log (odds) is desirable to support additive scorecard systems or maintain interpretability in downstream rules.

### SUMMARY

Methods, systems, and articles of manufacture, including computer program products that include a non-transitory computer readable medium storing instructions and/or computing systems that include one or more programmable processors, are provided that either include operations or are executable or operable to result in a set of operations that relate generally to tuning of machine learning models and in some embodiments more specifically to operations including processing a training dataset using a model architecture configured to generate an output score indicative of a predicted class probability for each data instance, computing a class-conditional divergence metric maximized for a fixed value of a weighting factor, optimizing parameters of the model architecture by maximizing the class-conditional divergence metric for a fixed value of the weighting factor, and generating a predictive output using the model architecture. The training dataset includes a plurality of labeled data instances, and each data instance is associated with a binary label. The weighting factor includes a hyperparameter (omega) configured to adjust a relative penalization applied to a variance of each class. The predictive output can, in some embodiments, be a clinical outcome prediction.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings, which show features consistent with one or more embodiments of the current subject matter:

FIG. 1 illustrates an exemplary architecture and process of a system 100 for training a binary classification model that enhances predictive performance and optimizes class separation;

FIG. 2 illustrates a representative visualization of how output score distributions for positive and negative classes may be influenced by adjusting a tunable hyperparameter;

FIG. 3A shows an example relationship between output scores and log-odds where the omega divergence objective is used with ω=0.5;

FIG. 3B shows the relationship between output scores and log-odds for a model trained using omega divergence with ω=0.7;

FIG. 3C shows the mapping of output scores to log-odds under omega divergence with ω=0.3;

FIG. 3D shows the output of a model trained with an ω value selected to minimize the curvature in the score-to-log (odds) relationship;

FIG. 4 shows a chart illustrating features of an iterative approach to optimizing model outputs;

FIG. 5 shows a set of diagrams illustrating additional features of an iterative approach to optimizing model outputs;

FIG. 6 is a diagram illustrating a flowchart 400 of a process for training a binary classification model; and

FIG. 7 depicts a block diagram illustrating a computing system.

When practical, like labels are used to refer to same or similar items in the drawings.

### DETAILED DESCRIPTION

The details of one or more variations of the subject matter described herein are set forth in the accompanying drawings. Various embodiments of the current subject matter relate to methods, systems, etc. for training a binary classification model that may improve predictive performance and optimize class separation. These and other possible benefits can be achieved in certain embodiments using improvements relating to optimizing hyperparameter divergence. As used herein hyperparameters are external configuration settings adjustable by the user before training a machine learning model for controlling training processes, model structure, and the like.

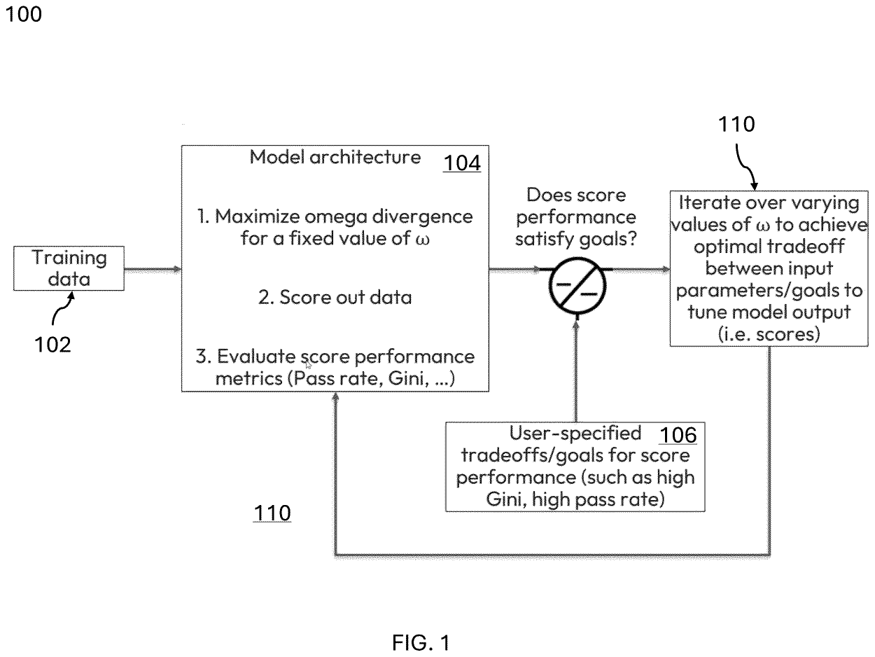

FIG. 1 illustrates features of an example architecture and process of a system 100 consistent with an embodiment of the current disclosure. In some embodiments, including those consistent with FIG. 1, benefits of the current subject matter can include enabling maximization of an objective function omega divergence, which can be otherwise stated as maximizing separation between score distributions for “positive” outcomes vs. “negative” outcomes. A method consistent with this embodiment can include defining an objective function that can, in some examples include a (hyper) parameter omega (defined below) and optimizing parameters of a model architecture by maximizing the objective function.

In some embodiments, training data, e.g., in a training dataset 102 comprising a plurality of labeled data instances, is processed by a model architecture 104. The term “model architecture” refers to a computational structure, such as, for example, a generalized additive model (GAM) configured to generate, for each input instance, an output score which can be interpreted as indicative of a predicted likelihood of class membership (in one example, this can be classes of “negatives” and “positives”). Other model types, such as for example neural networks, logistic regression models, or gradient-boosted decision trees (GBDT) are also contemplated within the scope of the current subject matter. In some embodiments, a GAM optimized by maximizing Omega Divergence may be substantially faster to train than neural networks. This benefit can become advantageous when tuning/optimizing the Omega hyperparameter towards operational goals in an outer-loop optimization.

In addition to generating a score output, model architecture 104 is further configured to maximize a hyperparameter divergence (i.e., an omega divergence representative of separation between the two classes) for a fixed value of ω, for example using fast Quadratic Programming (QP) techniques or the like, and to evaluate one or more model performance metrics, such as for example a pass rate (e.g., what percentage of score outcomes for a given set of test entities are above a “pass” threshold), a Gini (e.g., a metric measuring the ability of the model architecture to distinguish between the two classes). In this disclosure, ω is a scalar between 0 and 1 that adjusts a relative emphasis on positive and negative class variance. Omega divergence generally refers to a class-separation metric that may be used to assess how distinctly the model separates output scores of different classes, in other words, how well separated the score distribution is for two or more classes. A calculation of the omega divergence is described below. A weighting factor may be used in the denominator to control a relative penalization applied to each class's variance. In some embodiments, this allows flexible adjustment of the compression applied to score distributions for one or both classes. This approach does not evaluate operational metrics and their tradeoffs, thus greatly reducing the workload for this process.

The score performance metrics generated by the model architecture 104 are compared to a set of defined tradeoffs or goals for score performance 106, such as for example a high Gini, a high pass rate, etc.

In a further optimization operation, an iteration 110 occurs over varying values for ω while keeping track of all metrics important for the operation. In this manner an acceptable tradeoff between desired model performance parameters can be achieved by applying advanced multi-objective optimization technologies such as goal programming to tune the model output.

In some embodiments, a divergence-based training objective may be used to encourage separation between the output score distribution of positive and negative classes in a binary classification model. A traditional formulation, referred to herein as classic divergence, may serve as a baseline objective. The classic divergence is defined as:

$$DIV = \frac{{( {μ}_{P} - {μ}_{N} )}^{2}}{0.5 ( {σ}_{P}^{2} + {σ}_{N}^{2} )}$$

Where:

$${σ}_{P}^{2} and {σ}_{N}^{2}$$

denote the mean output scores for the positive and negative classes, respectively;
μₚ and μ_{N} represent the respective conditional variances of the output scores for each class.

This formulation seeks to maximize the squared difference between the class means, but at the expense of the average within-class variance. In some embodiments, it provides a symmetric treatment of the two classes, applying equal penalization to both variances. However, such symmetry may present limitations in real-world scenarios where class distributions are imbalanced, or where operational needs dictate that one class's output distribution be more tightly concentrated than the other. For example, it may be desirable for high-risk (positive) cases to yield scores within a narrow and well-separated range, whereas negative cases may tolerate greater variance.

To address this lack of flexibility, the approach described herein introduces a generalization referred to as omega divergence. The omega divergence extends the classic formulation by incorporating a tunable weighting factor, w, which allows asymmetric penalization of class-specific variances. The omega divergence is defined as:

$${DIV}_{ω} = \frac{{( {μ}_{P} - {μ}_{N} )}^{2}}{{ωσ}_{P}^{2} + ( 1 - ω ) {σ}_{N}^{2}} ;$$

where ω, as noted above, is a scalar between 0 and 1 that adjusts the relative emphasis on positive and negative class variance. When ω=0.5, the omega divergence reduces to the classic divergence. For values of ω greater than 0.5, the training process applies stronger penalization to the variance of the positive class; conversely, values less than 0.5 emphasize penalization of the negative class variance.

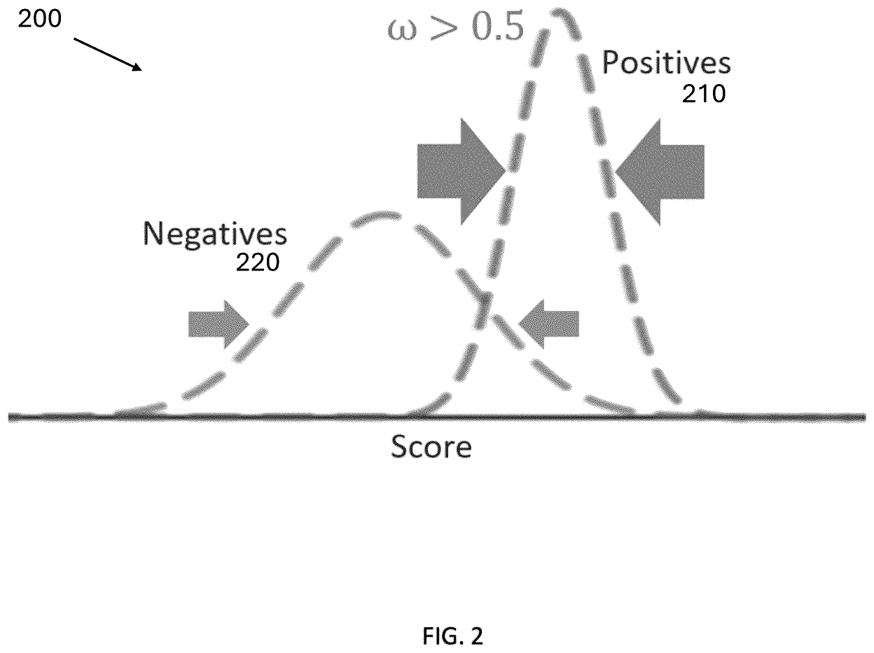

FIG. 2 shows a chart 200 illustrating a representative visualization of the omega divergence objective when ω is set to a value greater than 0.5. The horizontal axis represents model output scores, and the vertical axis represents probability density. The dashed curves indicate the conditional score distributions for the positive class 210 and negative class 220. In this example, the positive class distribution is shown to be narrower, with inward-pointing arrows indicating greater compression due to increased variance penalization. The negative class distribution is wider, reflecting reduced penalization. This illustrates that when the ω value exceeds 0.5, the stronger variance suppression is applied to the positive class, leading to a concentrated score distribution; conversely, the negative class receives less variance suppression, allowing its score distribution to remain more dispersed.

This visualization demonstrates how the omega divergence enables flexible control over score distribution shapes without altering the model architecture or inference-time behavior. By tuning ω, the system can promote separation between class means while directing variance minimization to the class where tighter output control is operationally desirable. This added configurability may be especially useful in applications such as medical diagnostics or credit scoring, where post-training score interpretation or deployment thresholds rely on predictable distributional behavior.

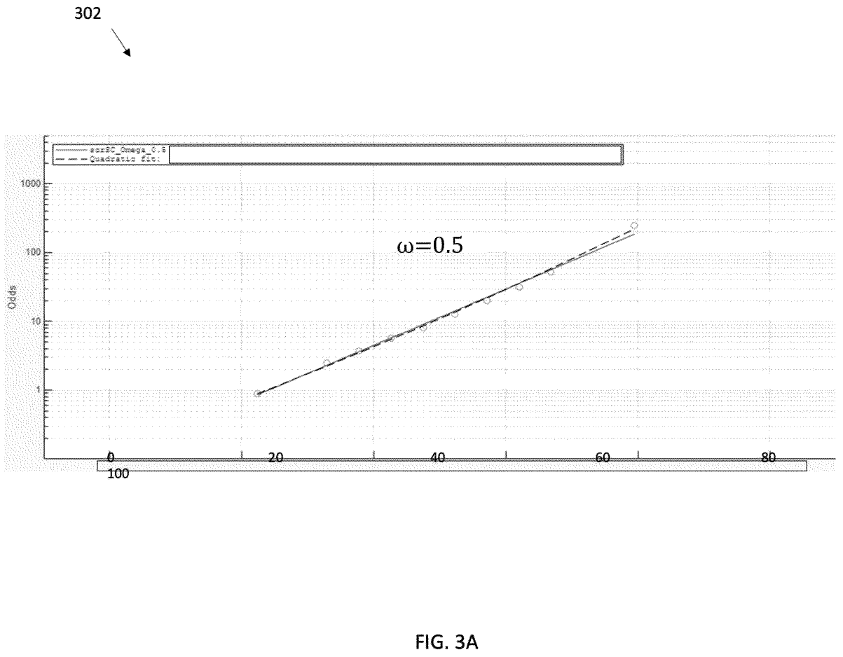

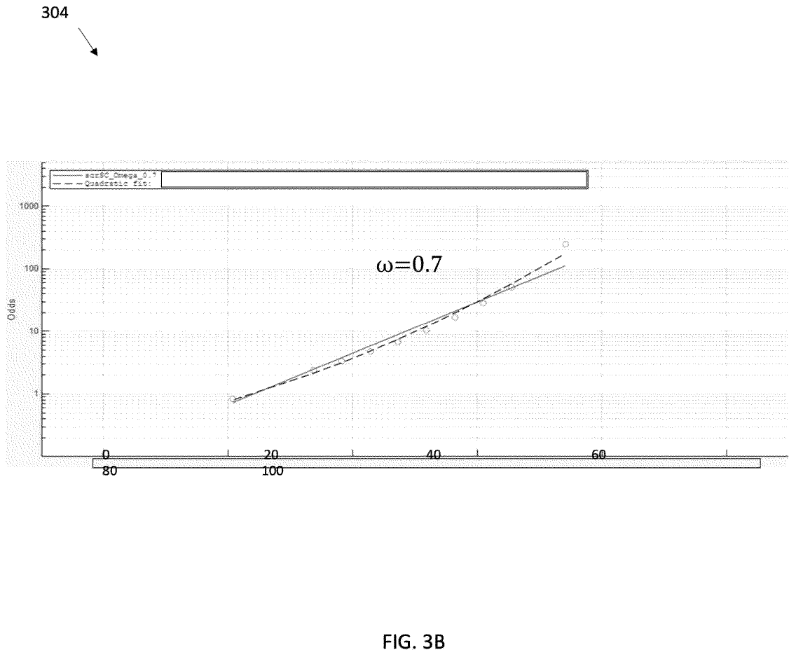

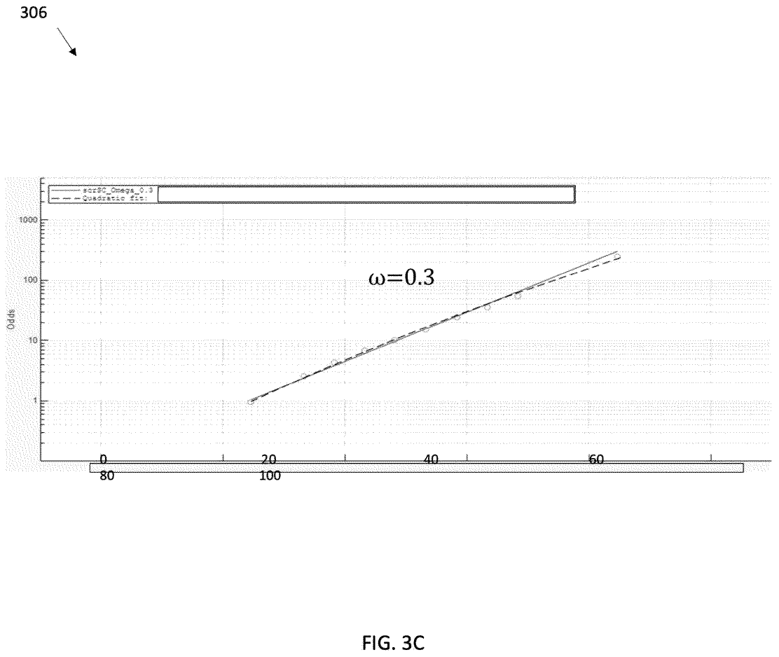

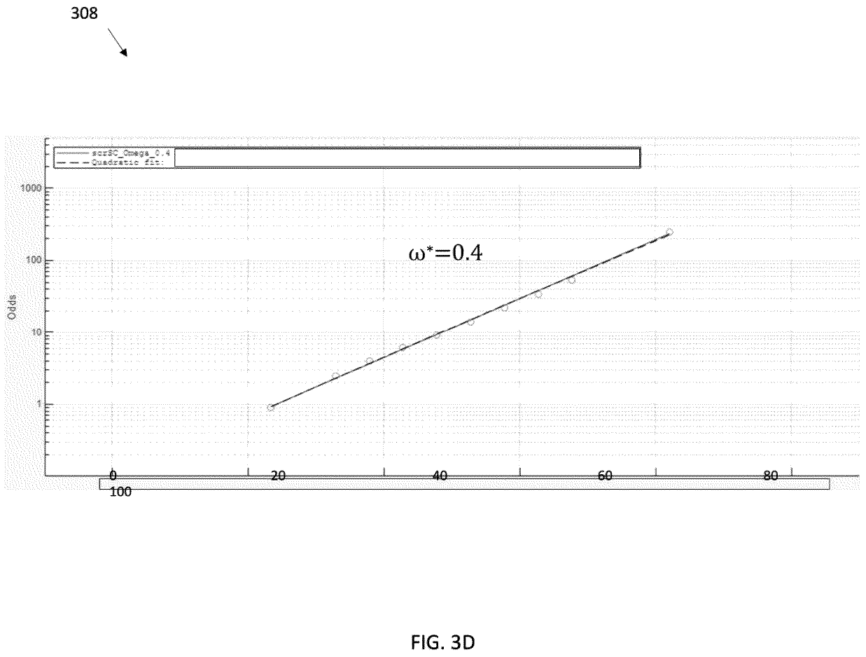

FIG. 3A shows an example relationship between output scores and log-odds where the omega divergence objective is used with ω=0.5. In this configuration, the objective reduces to the classic divergence formulation, which symmetrically penalizes the variances of both positive and negative class scores. As illustrated, the resulting curve is close to linear but exhibits mild convexity, particularly at the upper end of the score range. This indicates that while the score-to-log (odds) mapping is reasonably well-aligned, there remains some upward curvature. This form may limit score calibration when operational requirements call for a strictly linear or bounded relationship.

FIG. 3B shows the relationship between output scores and log-odds for a model trained using omega divergence with ω=0.7. In this case, the higher ω value applies stronger penalization to the variance of the positive class. As a result, the output score range is more compressed, especially at the upper end. The log (odds)-to-score curve appears more convex compared to FIG. 3A. This outcome suggests that with higher ω values, the optimization shifts more weight toward narrowing the positive class score distribution, yielding a nonlinear transformation that may enhance separation but reduce the usable scoring range for high-confidence predictions.

FIG. 3C shows the mapping of output scores to log-odds under omega divergence with ω=0.3. In this example, the lower ω value shifts the penalization emphasis toward the variance of the negative class. The resulting log (odds) curve becomes concave, especially toward the higher end of the score range. This reflects an expanded score range for higher-probability predictions. In some use cases, such behavior may lead to overconfidence in predictions near the positive class boundary, which may complicate interpretation or threshold tuning in operational settings.

FIG. 3D shows the output of a model trained with an ω value selected to minimize the curvature in the score-to-log (odds) relationship. This value, denoted ω*=0.4, may be identified through grid search or similar optimization methods. The resulting curve is nearly linear across the full score range, indicating a well-calibrated transformation. This result suggests that omega divergence may be tuned to produce score distributions that preserve linear interpretability in log-odds space without requiring additional post-training score transformation. In some embodiments, such behavior may be advantageous for scorecard deployment or downstream policy thresholding.

A process having one or more of the features of the described embodiment enables incorporation of distribution-shaping objectives during model training without requiring modification the model architecture or inference pipeline. For example, the training procedure may direct the model to produce output scores with class-separable means and tunable variances, potentially leading to improved score calibration, separation, or decision threshold behavior across deployment scenarios.

When training large binary classification models on big data sets with many observations and many variables, and when trading off potentially multiple performance measures against each other, a simple grid search can be slow and highly inefficient, posing a significant effort for data science teams and IT infrastructure.

Finding the “best” solution when there are multiple tradeoffs can be a highly iterative process, during which potentially unknown tradeoffs are first discovered, leading to repeated calls to data science teams by operational and domain experts. This can make progress towards the best solution (i.e. best “ω)” extremely slow.

To overcome this challenge, a further embodiment of the current subject matter can provide a graphical user interface (GUI) based application that allows domain experts, even those with no coding experience, to quickly determine the “best” “ω*” and with it, the best classifier and best score, to serve their operational objectives and constraints.

In one potential use case, an embodiment of the current subject matter can be applied as follows. A rank-ordering score may be developed by a date science team to make pass/fail decisions by comparing the rank-ordering score to a threshold. The threshold is hard-coded and fixed by the operation. The new score, while improving rank ordering over the old score, results in a lower pass rate than the old score. It is desirable to increase the pass rate with the new score. Traditional solutions for this operational challenge are lacking. However, the current subject matter enables tuning of an empirical cumulative distribution function of the new score such that the pass rate at the operationally fixed threshold may increase.

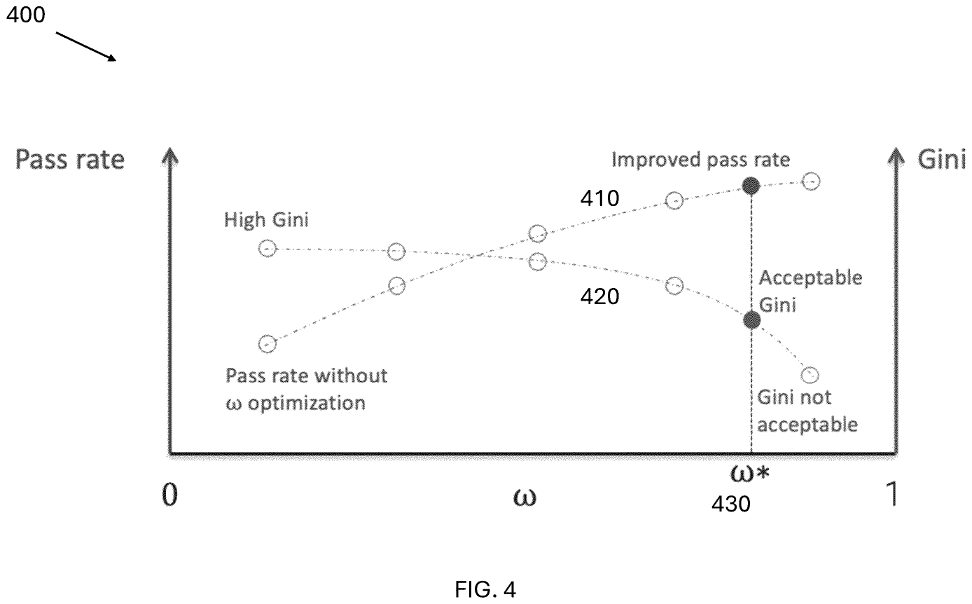

FIG. 4 shows a chart 400 whose example data illustrate tradeoffs between desired model output performance metrics, for example the tension between joint optimization of “ω” and other performance metrics. A principal challenge with adjusting, or optimizing, a tunable hyperparameter such as “ω”, are tradeoffs between different score performance metrics that matter for the operation. The example data shown in the chart 400 of FIG. 4 illustrate that when tuning “ω” to maximize a new pass rate 410 at a fixed score threshold, the new score's rank ordering power 420 (for example as measured by AUC or Gini) may deteriorate more than acceptable. The “best” value “ω*” 430 may then be found by a tradeoff analysis, where, in the example of FIG. 4, pass rate and Gini are evaluated at 6 grid points.

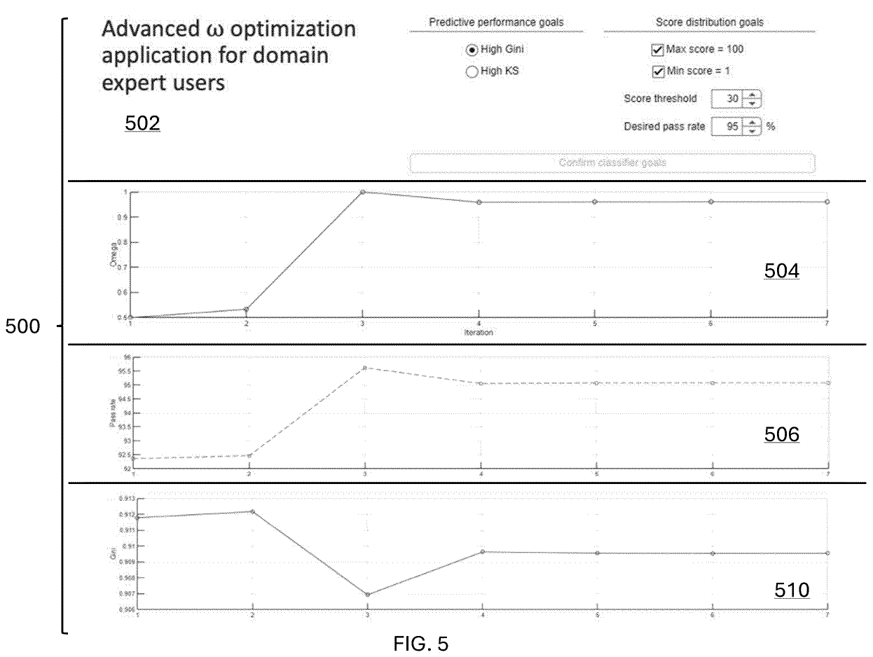

FIG. 5 shows a set of charts 500 illustrating an example of a graphical user interface 502 and three graph panels 504, 506, and 510 illustrating aspects of an iterative process employed by an embodiment of the current subject matter for achieving key desired metrics in a multivariate scoring system in which a set of desired output parameters need to be maintained throughout successive versions of the model underlying the scoring system.

Using the GUI 502, a domain expert user can enter goals and key metrics. In this example, the inputted desired outcomes are: a high Gini, a score distribution range between 1 and 100, and a pass rate equal to 95% at a score threshold of 30 on the 1 to 100 scale. In the first graph panel 504, starting from a neutral “ω”=0.5, the process iterates and rapidly converges to a “best” “ω” *=0.96 after only a few iterations. Another option for the user to choose in the GUI 502 is KS (Kolmogorov-Smirnov parameter). Gini measures overall model ranking performance (0-1 or 0-100%), and KS measures the maximum separation between cumulative distributions of “good” and “bad” cases.

The bottom two graph panels 506 and 510 show further details of this example of the progress of the optimization process. As shown in the graph panel 506, the pass rate improves markedly during the first 3 iterations. However, the graph panel 510 shows that the Gini metric deteriorates substantially. During subsequent iterations, the pass rate converges to the desired level (95%) while the Gini recovers to an acceptable level.

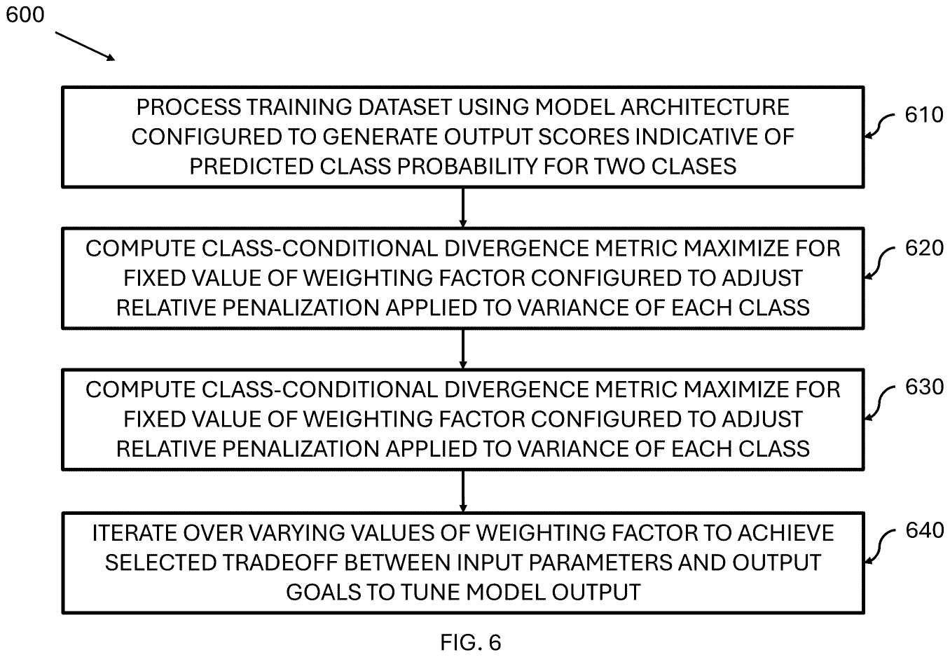

FIG. 6 is a diagram illustrating a flowchart 600 depicting features of a process for training a binary classification model, in accordance with one or more embodiments of the approach described herein. As shown in FIG. 6, the process 600 includes, at 610, processing a training dataset using a model architecture configured to generate, for each data instance of the dataset, an output score indicative of a predicted class probability. The training dataset comprises a plurality of labeled data instances, and each data instance can be associated with a binary label (e.g., 0 or 1). The labels may reflect class membership such as positive or negative outcomes in a classification task.

In some embodiments, the model architecture is a generalized additive model configured to generate output scores from input features, for example allowing gradient-based optimization of the composite loss function during training. In some embodiments, the output score may be a raw logit value generated prior to applying an activation function such as a sigmoid function. In other implementations, the model architecture may include a neural network or other supervised learning system that transforms a set of input features into the corresponding output score.

At 620, a class-conditional divergence metric maximized for a fixed value of a weighting factor is computed. The weighting factor includes a hyperparameter (omega) configured to adjust a relative penalization applied to a variance of each class. In some embodiments, the divergence score is computed based on a squared difference between average output scores corresponding to the two classes (i.e., the class-specific means), normalized by a weighted combination of the variances of the output scores within each class. A weighting factor is used to modulate the contribution of each class's variance to the denominator. This weighting factor may be a tunable hyperparameter selected from a range between 0 and 1 to adjust the relative penalization applied to each class's variance. For example, the weighting factor may be selected to suppress variance in the class having fewer data instances, which may be desirable in imbalanced classification scenarios.

At 630, parameters of the model architecture are optimized by maximizing the class-conditional divergence metric for a fixed value of the weighting factor (omega). In some embodiments, standard optimization procedures such as stochastic gradient descent, Adam, or other backpropagation-compatible optimizers may be applied during training.

In some embodiments, the training dataset may exhibit a class imbalance, wherein one class contains substantially fewer data instances than the other. In such cases, the minority class may be more susceptible to output score variance due to limited representation in the data. To mitigate this, the weighting factor ω used in the computation of the class-conditional divergence score may be selected to apply stronger penalization to the variance of the minority class. For example, if the positive class comprises fewer instances, a higher ω value may be used to suppress the variance of positive class scores. Conversely, when the negative class is underrepresented, a lower ω value may be preferred. This approach helps stabilize the score distribution of the minority class during training, which may in turn improve model reliability and threshold-based decision performance in downstream applications.

In some embodiments, the weighting factor ω is treated as a tunable hyperparameter. The value of ω may be selected prior to training, either manually or via automated hyperparameter optimization techniques, such as grid search or Bayesian search. This selection process may be guided by evaluation metrics such as divergence score magnitude, score calibration, or downstream performance objectives. For example, a user may perform a grid search across a range of ω values between 0 and 1, identifying the setting that yields the best trade-off between class separation and score distribution shape. In particular, ω values closer to 1 may tighten the positive class distribution, while values closer to 0 emphasize compression of the negative class. This flexibility allows practitioners to adapt the training behavior to specific operational constraints, such as reducing overlap in score distributions, aligning scores to required monotonic transformation curves, or satisfying fairness or interpretability criteria.

In a further, optional, embodiment of the current subject matter, at 640 the process includes iterating over varying values of the weighting factor to achieve a selected tradeoff between input parameters and output goals to tune the model output. For example, one or more target parameter features may be defined by a user, and the iterating can result in tuning the model output such that the defined tradeoffs are achieved.

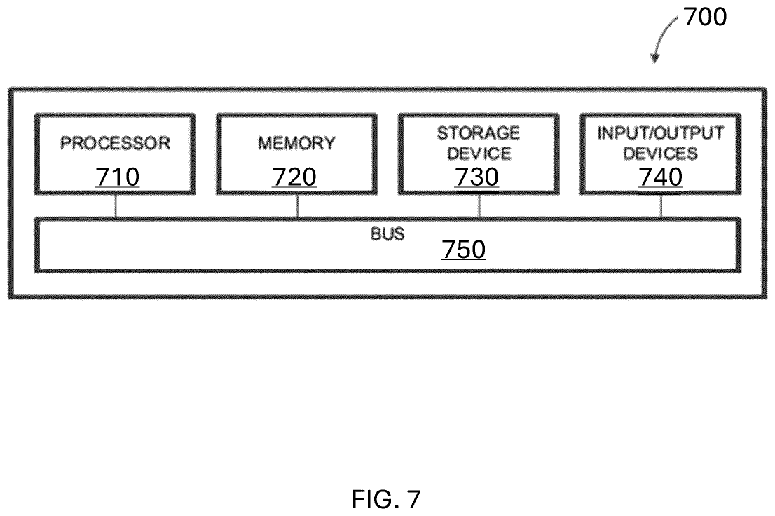

FIG. 7 depicts a block diagram illustrating a computing system 700 consistent with implementations of the current subject matter. As shown in FIG. 7, the computing system 700 can include a processor 710, a memory 720, a storage device 730, and input/output devices 740. The processor 710, the memory 720, the storage device 730, and the input/output devices 740 can be interconnected via a system bus 750. The computing system 700 may additionally or alternatively include a graphic processing unit (GPU), such as for image processing, and/or an associated memory for the GPU. The GPU and/or the associated memory for the GPU may be interconnected via the system bus 750 with the processor 710, the memory 720, the storage device 730, and the input/output devices 740. The memory associated with the GPU may store one or more images described herein, and the GPU may process one or more of the images described herein. The GPU may be coupled to and/or form a part of the processor 710. The processor 710 is capable of processing instructions for execution within the computing system 700. In some implementations of the current subject matter, the processor 710 can be a single-threaded processor. Alternately, the processor 710 can be a multi-threaded processor. The processor 710 is capable of processing instructions stored in the memory 720 and/or on the storage device 730 to display graphical information for a user interface provided via the input/output device 740.

In some implementations of the current subject matter, the computing system 700 can be used to execute various interactive computer software applications that can be used for organization, analysis and/or storage of data in various (e.g., tabular) format (e.g., Microsoft Excel®, and/or any other type of software). Alternatively, the computing system 700 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 740. The user interface can be generated and presented to a user by the computing system 700 (e.g., on a computer screen monitor, etc.).

The memory 720 is a computer-readable medium, such as volatile or non-volatile memory, that stores information within the computing system 700. The memory 720 can store data structures representing configuration object databases, for example. The storage device 730 is capable of providing persistent storage for the computing system 700. The storage device 530 can be a floppy disk device, a hard disk device, an optical disk device, or a tape device, or other suitable persistent storage means. The input/output device 740 provides input/output operations for the computing system 700. In some implementations of the current subject matter, the input/output device 740 includes a keyboard and/or pointing device. In various implementations, the input/output device 740 includes a display unit for displaying graphical user interfaces.

According to some implementations of the current subject matter, the input/output device 740 can provide input/output operations for a network device. For example, the input/output device 740 can include Ethernet ports or other networking ports to communicate with one or more wired and/or wireless networks (e.g., a local area network (LAN), a wide area network (WAN), the Internet).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

### Use Case 1

In modern critical care settings, early identification of life-threatening conditions such as sepsis is essential for improving patient outcomes. Binary classification models are increasingly used to support such diagnostic decisions by generating risk scores based on continuously collected patient data. A common requirement in these clinical environments is not only that the model provides accurate classifications (i.e., identifying septic vs. non-septic patients) but also that the generated output scores support consistent interpretation across different operational thresholds and deployment scenarios, including, for example version changes of the underlying analytical models. Such consistency is necessary so that end users are able to maintain diagnostic metrics and planned treatment outcome thresholds even if the underlying analytics are updated or improved.

A hospital data science team develops a model trained to predict sepsis onset within the next 12 hours, using a large training dataset consisting of labeled patient records collected from multiple ICU centers. Each data instance is associated with a binary label indicating whether the patient was subsequently diagnosed with sepsis. The model architecture processes input features such as heart rate, white blood cell count, temperature, and lactate levels to produce an output score indicative of the likelihood of sepsis.

After initial training for example using a standard binary cross-entropy loss, the team observes a key challenge: although the model achieves strong classification accuracy, the distribution of output scores is skewed relative to previous predictive models. In particular, the positive class (septic patients) exhibits wide variance in predicted scores, with many high-risk cases receiving scores close to the middle of the probability scale (e.g., 0.5-0.7). This distributional behavior complicates the use of risk thresholds in downstream clinical decision rules. For instance, clinicians may wish to trigger early alerts or order additional tests for patients exceeding a certain score threshold (e.g., 0.6), but the overlap in score distributions between classes makes it difficult to choose thresholds that maintain both sensitivity and specificity.

To address this, the model can be modified using an embodiment of the current subject matter. The divergence score is computed based on the squared difference between the average output scores of the positive and negative classes, normalized by a weighted combination of their respective score variances. A weighting factor is configured to control the relative penalization applied to each class's variance. In this use case, since septic cases are relatively rare in the dataset, the weighting factor is selected to apply stronger penalization to the variance of the positive class. This encourages the model to produce more tightly clustered output scores for septic patients, improving score interpretability and supporting confident identification of high-risk cases.

After retraining with the divergence-based regularization, the team evaluates the model on a held-out test set and observes several benefits. First, the positive class score distribution becomes more compact and better separated from the negative class, with higher average predicted scores for septic patients. Second, threshold tuning becomes more stable across different operating points. For example, using a threshold of 0.65 now yields higher precision while maintaining recall, allowing clinicians to prioritize follow-up for high-confidence predictions.

Furthermore, the hospital's existing electronic health record system uses a log (odds)-to-score transformation to present risk scores in a standardized format ranging from 0 to 100. In previous iterations, the nonlinear mapping from output scores to log (odds) required additional transformation layers or post-processing steps, which introduced complexity and hindered explainability. With the divergence-based regularization, the team is able to tune the weighting factor to yield a near-linear relationship between output scores and log (odds), eliminating the need for downstream corrections and ensuring compatibility with existing scorecard infrastructure.

This approach allows the clinical analytics pipeline to retain the original model architecture and inference procedure while producing output scores that are better aligned with practical decision-making needs. Physicians are now able to interpret the model's risk scores with greater confidence, and hospital administrators can define policy thresholds knowing that the score distribution behavior is predictable and stable, even under shifting data environments or patient population distributions.

In summary, this use case illustrates how incorporating a class-conditional divergence score into the training objective enables precise control over output score distributions in a high-stakes binary classification setting. It supports improved class separation, enhances model interpretability, and ensures deployment compatibility in operational medical environments such as early sepsis detection in ICUs.

In the descriptions above and in the claims, phrases such as “at least one of or “one or more of may occur followed by a conjunctive list of elements or features. The term “and/or may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B; “one or more of A and B; and “A and/or B are each intended to mean “A alone, B alone, or A and B together. A similar interpretation is also intended for lists including three or more items. For example, the phrases “at least one of A, B, and C; “one of more of A, B, and C; and “A, B, and/or C are each intended to mean “A alone, B alone, C alone, A and B together, A and C together, B and C together, or A and B and C together. Use of the term “based on, above and in the claims is intended to mean, “based at least in part on, such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for training a binary classification model, comprising:
processing a training dataset using a model architecture configured to generate, for each data instance, an output score indicative of a predicted class probability, the training dataset comprising a plurality of labeled data instances, each data instance associated with a binary label;
computing a class-conditional divergence metric maximized for a fixed value of a weighting factor, the weighting factor comprising a hyperparameter (omega) configured to adjust a relative penalization applied to a variance of each class; and
optimizing parameters of the model architecture by maximizing the class-conditional divergence metric for a fixed value of the weighting factor;
generating a predictive output using the model architecture.

2. The method of claim 1, further comprising iterating over varying values of the weighting factor to achieve a selected tradeoff between input parameters and output goals to tune the model output.

3. The method of claim 2, wherein the output goals comprise one or more of a maximizing a Kolmogorov-Smirnov parameter, maximizing a Gini, maximizing a score distribution, or achieving a desired pass rate.

4. The method of claim 1, wherein the divergence score is computed based on a squared difference between average output scores corresponding to the two classes, normalized by a weighted combination of their respective score variances.

5. The method of claim 1, wherein the binary classification model comprises a generalized additive model (GAM) configured to generate the output scores from a set of input features.

6. The method of claim 1, wherein the weighting factor is a tunable hyperparameter selected from a range between 0 and 1 to control a contribution of each class's variance to the divergence score.

7. The method of claim 1, wherein the training dataset comprises an imbalanced distribution of binary labels, and the weighting factor is selected to suppress variance in one of the classes.

8. The method of claim 1, wherein the output scores are raw logit values generated prior to applying a sigmoid.

9. A system for training a binary classification model, comprising:
at least one programmable processor; and
a non-transient machine-readable medium storing instructions that, when executed by the processor, cause the at least one programmable processor to perform operations comprising:
processing a training dataset using a model architecture configured to generate, for each data instance, an output score indicative of a predicted class probability, the training dataset comprising a plurality of labeled data instances, each data instance associated with a binary label;
computing a class-conditional divergence metric maximized for a fixed value of a weighting factor, the weighting factor comprising a hyperparameter (omega) configured to adjust a relative penalization applied to a variance of each class;
optimizing parameters of the model architecture by maximizing the class-conditional divergence metric for a fixed value of the weighting factor; and
generating a predictive output using the model architecture.

10. The system of claim 9, further comprising iterating over varying values of the weighting factor to achieve a selected tradeoff between input parameters and output goals to tune the model output.

11. The system of claim 10, wherein the output goals comprise one or more of a maximizing a Kolmogorov-Smirnov parameter, maximizing a Gini, maximizing a score distribution, or achieving a desired pass rate.

12. The system of claim 9, wherein the divergence score is computed based on a squared difference between average output scores corresponding to the two classes, normalized by a weighted combination of their respective score variances.

13. The method of claim 9, wherein the binary classification model comprises a generalized additive model (GAM) configured to generate the output scores from a set of input features.

14. The method of claim 9, wherein the weighting factor is a tunable hyperparameter selected from a range between 0 and 1 and to control a contribution of each class's variance to the divergence score.

15. The method of claim 9, wherein the training dataset comprises an imbalanced distribution of binary labels, and the weighting factor is selected to suppress variance in one of the classes.

16. A computer program product for training a binary classification model, comprising a non-transient machine-readable medium storing instructions that, when executed by at least one programmable processor, cause the at least one programmable processor to perform operations comprising:
processing a training dataset using a model architecture configured to generate, for each data instance, an output score indicative of a predicted class probability, the training dataset comprising a plurality of labeled data instances, each data instance associated with a binary label;
computing a class-conditional divergence metric maximized for a fixed value of a weighting factor, the weighting factor comprising a hyperparameter (omega) configured to adjust a relative penalization applied to a variance of each class;
optimizing parameters of the model architecture by maximizing the class-conditional divergence metric for a fixed value of the weighting factor; and
generating a predictive output using the model architecture.

17. The computer program product of claim 16, further comprising iterating over varying values of the weighting factor to achieve a selected tradeoff between input parameters and output goals to tune the model output, wherein the output goals comprise one or more of a maximizing a Kolmogorov-Smirnov parameter, maximizing a Gini, maximizing a score distribution, or achieving a desired pass rate.

18. The computer program product of claim 16, wherein the divergence score is computed based on a squared difference between average output scores corresponding to the two classes, normalized by a weighted combination of their respective score variances.

19. The computer program product of claim 16, wherein the binary classification model comprises a generalized additive model (GAM) configured to generate the output scores from a set of input features.

20. The computer program product of claim 16, wherein the predictive output comprises a clinical outcome for one or more patients.
